(19) United States
(12) Patent Application Publication
(10) Pub. No.: US 2003/0099420 A1
(43) Pub. Date: May 29, 2003

(54) Electro-optic modulator

(76) Inventors: Achintya Bhowmik, San Jose, CA (US); Michael Skinner, San Jose, CA (US)

Correspondence Address: Charles K. Young, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/991,337

(22) Filed: Nov. 13, 2001

(51) Int. Cl. G02F 1/035; G02B 6/10

(52) U.S. Cl. 385/2; 385/129

(57) ABSTRACT

An electro-optic modulator comprises two electrodes and a waveguide. The waveguide is formed between the electrodes in the presence of an electric field.

### FIELD

The described invention relates to the field of optical signal modulation. In particular, the invention relates to an apparatus and method for making an electro-optic modulator using an organic material.

### BACKGROUND

An electro-optic modulator modulates a light signal by changing the phase of the light signal and then using constructive or destructive interference to intensify or cancel the light signal. The phase modulation is achieved by changing the index of refraction of the optical medium through which the light signal travels. The index of refraction is changed via an electric signal applied to the electro-optic modulator.

Electro-optic modulators may be made from bulk crystal or may be waveguide based. An electro-optic modulator made from bulk crystal typically uses an optical medium having physical dimensions on the order of millimeters or centimeters. Waveguide-based electro-optic modulators may have an optical medium having transverse waveguide cross-section dimensions on the order of microns.

Lithium Niobate (LiNbO3) is one material that has been used as an optical medium. It has an electro-optic (EO) coefficient of approximately 30 pm/V at telecommunication wavelengths (centered around approximately 1310 nm or 1550 nm), wherein a higher EO coefficient indicates a better ability to modulate the light.

### BRIEF DESCRIPTION OF THE DRAWINGS

FIGS. 1A-1I are schematic diagrams showing cross-sectional views of one embodiment of a process for making the phase modulator portion of an electro-optic modulator.

FIG. 1A is a schematic diagram showing a cross-sectional view of a dielectric 12 deposited on a substrate 10.

FIG. 1B shows a metal layer placed on top of the dielectric.

FIG. 1C shows two electrodes made from the metal layer.

FIG. 1D shows a dielectric layer deposited on top of the two electrodes.

FIG. 1E shows contacts being opened up through the dielectric layer to the underlying electrodes.

FIG. 1F shows a waveguide comprising an organic material that is allowed to form in the cavity between the two electrodes.

FIG. 1G shows the organic crystal and the two electrodes after a chemical/mechanical polishing (CMP) to yield a flat top surface.

FIG. 1H shows a second dielectric layer deposited over the waveguide and electrodes.

FIG. 1I shows reopening contacts on the electrodes through a second dielectric layer.

FIG. 2 is a schematic diagram of one embodiment of an electro-optic modulator comprising the phase modulator 5 described with respect to FIGS. 1A-1I incorporated into a Mach Zehnder structure.

FIG. 3 is a schematic diagram of another embodiment of an electro-optic modulator comprising the phase modulator 5 described with respect to FIGS. 1A-1I.

FIG. 4 is a block diagram that shows an example system using an electro-optic modulator.

### DETAILED DESCRIPTION

A method and apparatus for modulating an optical signal is disclosed. In one embodiment, an organic crystalline material is used as a waveguide of the phase modulator portion of an electro-optic modulator. The organic crystalline material is formed in the presence of an electric field as will be described in detail.

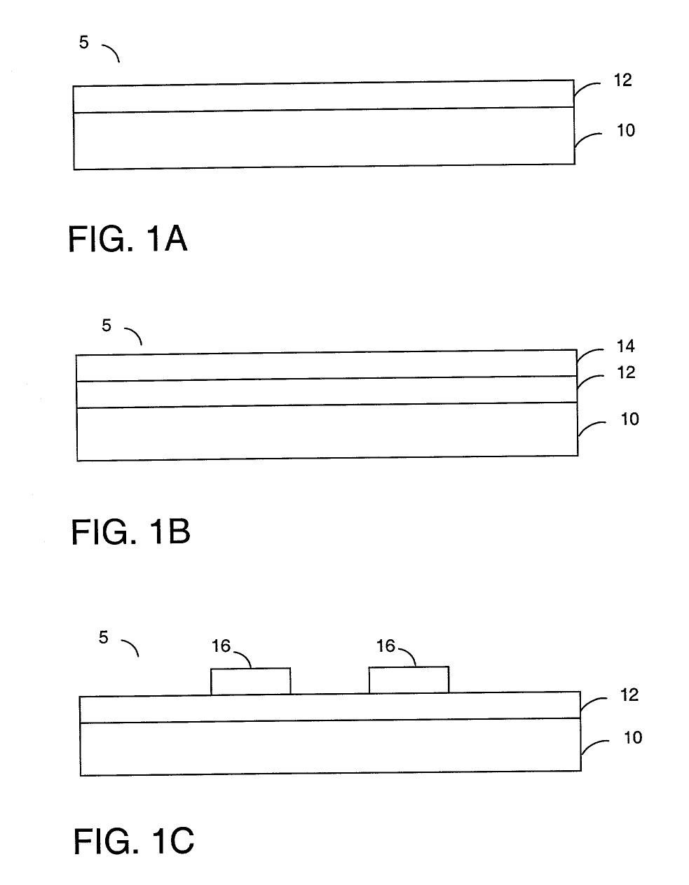

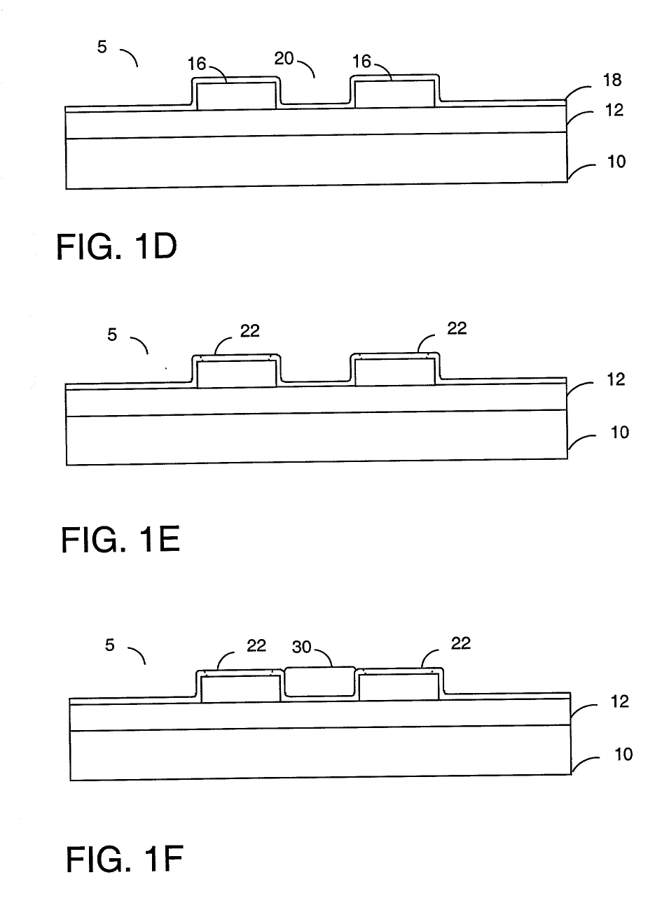

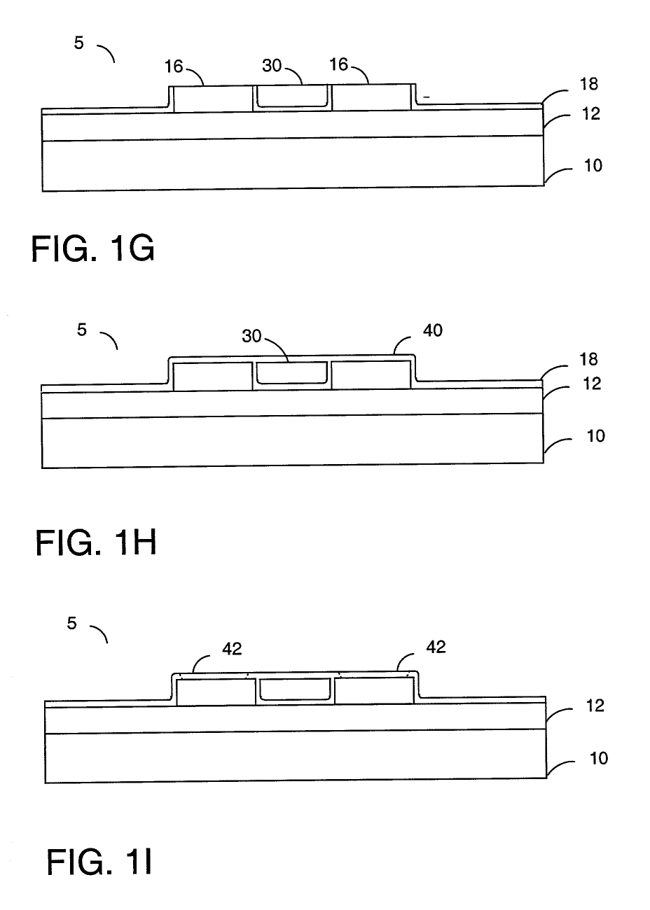

FIGS. 1A-1I are schematic diagrams showing cross-sectional views of one embodiment of a process for making the phase modulator portion 5 of an electro-optic modulator. FIG. 1A is a schematic diagram showing a cross-sectional view of a dielectric 12 deposited on a substrate 10. In one embodiment, a thin film layer of silicon dioxide is grown on a silicon substrate.

FIG. 1B shows a metal layer 14 placed on top of the dielectric 12. The metal layer 14 can be any one of various metals including, but not limited to, copper and aluminum. In one embodiment, the particular metal used is picked for its hardness as will be described with respect to FIG. 1G.

FIG. 1C shows two electrodes 16 made from the metal layer 14. In one embodiment, the electrodes are patterned to predetermined dimensions using a photolithographic process of masking and etching as is well-known.

FIG. 1D shows a dielectric layer 18 deposited on top of the two electrodes 16. In one embodiment, the dielectric layer 18 is silicon dioxide. In one embodiment, the dielectric layer 18 is carefully deposited to define a cavity 20 of a predetermined dimension between the two electrodes 16.

FIG. 1E shows contacts being opened up through the dielectric layer to the underlying electrodes. In one embodiment, etching is used to expose the two electrodes 16 to form contacts 22.

FIG. 1F shows a waveguide 30 comprising an organic material that is allowed to form in the cavity 20 (FIG. 1D) between the two electrodes 16. In one embodiment, an organic crystal is grown in the presence of a DC electric field created by applying a voltage to the two electrodes 16 via the contacts 22. The electric field causes the dipole moments of the organic material's molecules to substantially align with the electric field in a common direction. Once the organic material crystallizes its molecules are locked into alignment wherein the crystallographic orientation is dictated by the direction of the applied electric field. Although polymers may be aligned similarly, an organic crystal has an advantage that it does not exhibit “creep” like polymers do. Thus, the alignment and organization of molecules in the organic crystals do not de-stabilize over time.

An organic crystal may be grown by different methods. In one embodiment, the organic crystal is grown by a controlled evaporation of a solution. In an alternative embodiment, the organic crystal is grown by a controlled cooling of a melt.

In an example embodiment, the organic crystal molecules comprise an electron donor portion (“donor portion”) coupled to an electron acceptor portion (“acceptor portion”) via a conjugated backbone. A conjugated backbone is a molecule or a portion of one in which at least three carbons adjacent to each other are sp2 hybridized and contain one Pi bonding pair. Examples of conjugated backbone include aromatic hydrocarbon ring systems in which all the carbons within the ring are sp2 hybridized. Benzene is an example of such a conjugated system. The benzene ring has six carbons with alternating double and single bonds around the ring. All the ring carbons are sp2 hybridized having a free “p” orbital with one electron in the “p” orbital. Since all the carbons have the “p” orbital this forms an unbroken p orbital pipeline so that Pi electrons can travel throughout. The Pi electrons making up the three Pi bonds within the ring are said to be “delocalized Pi electrons”. This freedom for the Pi electrons adds extra stability called resonance stability. Other atoms such as nitrogen can replace one or more carbon atoms in the conjugated backbone.

Table 1 shows examples of organic materials that may be used to form the waveguide 30. The organic materials comprise donor and acceptor portions coupled via a conjugated backbone. In Table 1, the acceptor portions are designated with a dotted circle or ellipse, and the donor portions are designated with a dotted box. However, the organic molecules listed in Table 1 are by no means exhaustive. Other organic molecules may be employed as long as they exhibit a dipole moment that can be affected by an electric field, and they crystallize. Styrylpyridinium cyanine dye (SPCD) and 4′-dimethylamino-N-methyl-4 stilbazolium tosylate (DAST) are good modulator materials since they both have very high EO coefficients exceeding 500 pm/V.

FIG. 1G shows the organic crystal 30 and the two electrodes after a chemical/mechanical polishing (CMP) to yield a flat top surface. In one embodiment, the CMP is performed down to the top surface of the metal electrodes 16, wherein the electrode material is selected to have a hardness that resists the CMP and the CMP equipment terminates when it reaches and detects the electrodes.

FIG. 1H shows a second dielectric layer 40 deposited over the waveguide and electrodes. The second dielectric layer 40 serves as a top cladding for the waveguide 30. It should be noted that the processing temperature for applying the dielectric layer should be below the critical temperature of the organic crystal so as not to allow the crystalline structure and dipole moment alignment to be lost.

FIG. 1I shows reopening contacts 42 on the electrodes through the second dielectric layer. In one embodiment a lithographic technique is used to create the contacts.

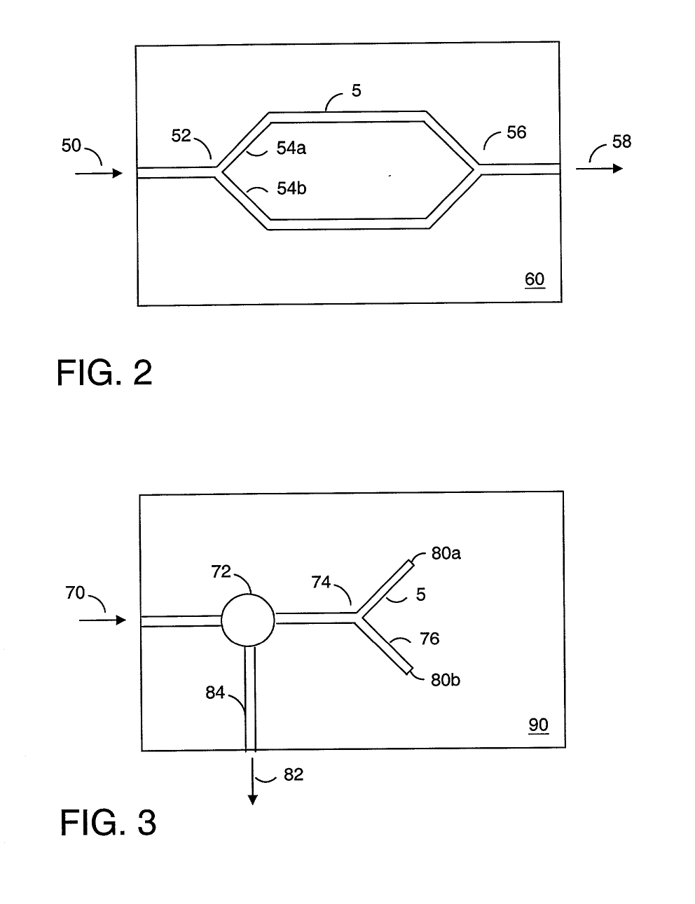

FIG. 2 is a schematic diagram of one embodiment of an electro-optic modulator comprising the phase modulator 5 described with respect to FIGS. 1A-1I incorporated into a Mach Zehnder structure. An optical signal input 50 enters the Mach Zehnder structure and is split by a coupler splitter 52. In one embodiment, the coupler splitter 52 is a 3 db coupler and the optical signal is split with equivalent portions directed into waveguides 54a and 54b. Waveguide 54a is coupled to the phase modulator portion 5, in which the phase of the optical signal is modulated by voltage applied to the electrodes of the phase modulator changing the index of refraction of the optical medium. The split optical signals from the phase modulator portion 5 and the lower waveguide 54b are recombined through coupler 56, at which, depending on the difference in phases of the two split optical signals, the signal out 58 may be either intensified by constructive interference or canceled by destructive interference. In one embodiment, the entire Mach Zehnder structure is implemented on a silicon substrate 60, however, portions of the structure could alternatively be implemented using fiber optic or other substrate materials.

FIG. 3 is a schematic diagram of another embodiment of an electro-optic modulator comprising the phase modulator 5 described with respect to FIGS. 1A-1I. An optical signal 70 enters a circulator 72 and then is split by a coupler splitter 74. In one embodiment, the coupler splitter 74 is a 3 db coupler and the optical signal is split with equivalent portions directed into phase modulator portion 5 and waveguide 76. The split optical signals pass through their respective phase modulator portion 5 and waveguide 76 and are reflected off surfaces 80a and 80b, respectively. The reflected optical signals are constructively or destructively coupled together through the coupler 74 and, depending upon their phase difference, the signal output may be either intensified by constructive interference or canceled by destructive interference. The signal output is directed from the coupler 74 to the circulator 72. The signal output 82 is directed out of the circulator 72 through a waveguide 84. In one embodiment, the circulator 72, coupler 74, phase modulator 5 and waveguides 76 and 84 are implemented in a common substrate 90. In another embodiment, the coupler 74, phase modulator 5, and waveguide 76 are in a common substrate 90 that does not include the circulator 72. The substrate 90 may be implemented in silicon or other materials.

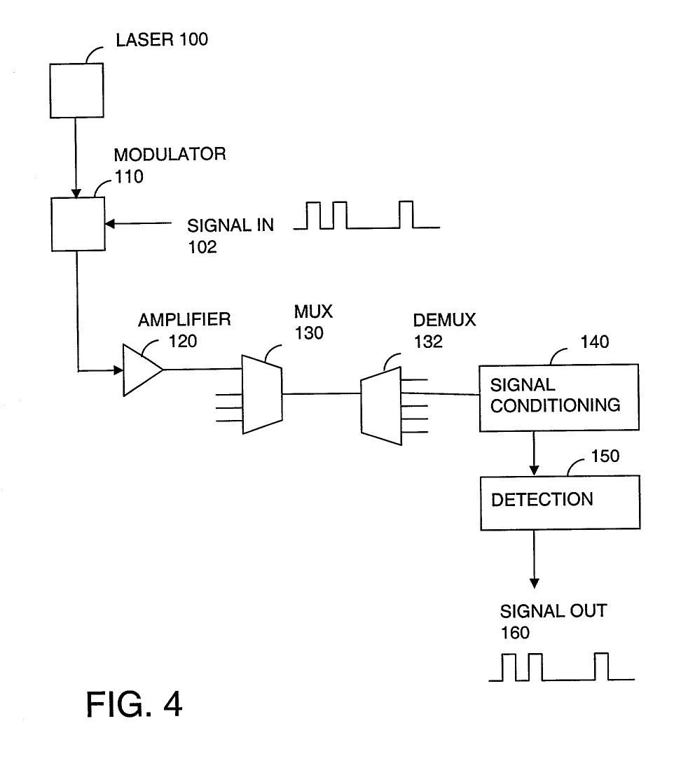

FIG. 4 is a block diagram that shows an example system using an electro-optic modulator. A laser 100 provides a light signal to the EO modulator 110. SIGNAL IN 102 provides the voltage input that is provided to the electrodes 16 of the electro-optic modulator. The SIGNAL IN modulates the light signal provided by the laser 100. The modulated light signal may then be amplified by amplifier 120 and then combined with other light signals using a multiplexer (MUX) 130. The light signals are later separated out again with a demultiplexer (DEMUX) 132. In one embodiment, an array waveguide grating may be used as the MUX 130 and DEMUX 132. The light signal may then be conditioned to correct for light dispersion, noise or other attenuation 140, and detection circuitry 150 then produces a SIGNAL OUT 160.

Thus, an electro-optic modulator and method for making the same is disclosed. However, the specific arrangements and methods described herein are merely illustrative. Numerous modifications in form and detail may be made without departing from the scope of the invention as claimed below. The invention is limited only by the scope of the appended claims.

TABLE 1

| | |
|---|---|
| 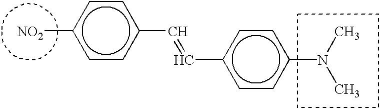 | DANS |
| 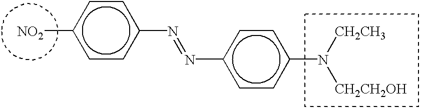 | Disperse Red 1 (DR 1) |
| 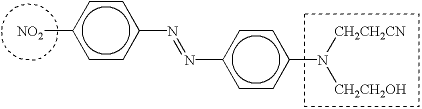 | Disperse Orange 25 (DO 25) |
| 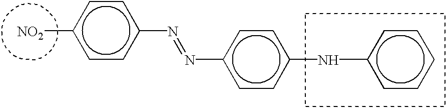 | Disperse Orange 1 (DO 1) |
| 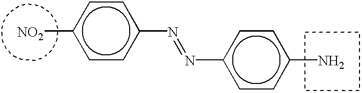 | Disperse Orange 3 (DO 3) |
| 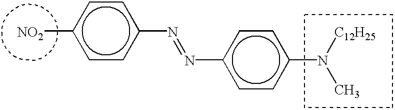 | TCSF |
| 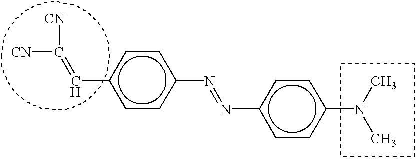 | DCV |
| 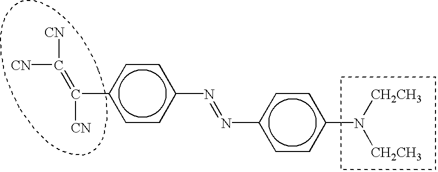 | TCV |
| 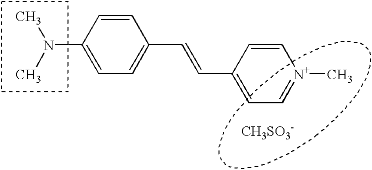 | styrylpyridinium cyanine dye (SPCD) |
| 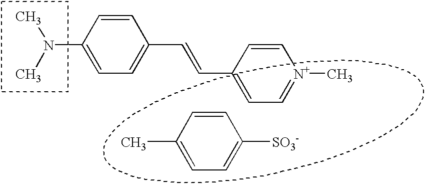 | 4′-dimethylamino-N-methyl-4- stilbazolium tosylate (DAST) |

What is claimed is:

1. A method of making a device comprising:
forming two electrodes;
creating an electric field between the two electrodes; and
forming a waveguide between the two electrodes in the presence of the electric field.

2. The method of claim 1, wherein the two electrodes are lithographically-defined on a substrate.

3. The method of claim 2, wherein the waveguide comprises an organic crystal material.

4. The method of claim 3, wherein the organic crystal material comprises an organic molecule comprising:
a doner portion, and
an acceptor portion coupled to the doner portion via a conjugated backbone.

5. An electro-optic modulator comprising:
two electrodes; and
a waveguide disposed between the two electrodes, the waveguide comprising an organic crystal.

6. The electro-optic modulator of claim 5, wherein the organic crystal comprises:
a doner portion, and
an acceptor portion coupled to the doner portion via a conjugated backbone.

7. The electro-optic modulator of claim 6, wherein the conjugated backbone comprises an aromatic ring.

8. The electro-optic modulator of claim 7, wherein the aromatic ring is a benzene ring.

9. The electro-optic modulator of claim 5, wherein the waveguide was formed in the presence of an electric field created between the two electrodes.

10. The electro-optic modulator of claim 5, wherein the waveguide is a non-centrosymmetric organic material with substantially aligned dipole moments.

11. The electro-optic modulator of claim 10, wherein the dipole moments were aligned using an electric field created between the two electrodes.

12. A method of making an electro-optic modulator comprising:
forming two electrodes on a substrate;
depositing a dielectric layer at least partially between the two electrodes;
creating an electric field between the two electrodes;
forming a waveguide over the dielectric layer in the presence of the electric field; and
depositing a top cladding over the waveguide.

13. The method of claim 12 further comprising:
polishing the waveguide prior to depositing the top cladding.

14. The method of claim 13 further comprising:
polishing the waveguide down to a top surface of the two electrodes.

15. The method of claim 12, wherein forming of the waveguide further comprises:
growing a crystal by a controlled cooling of a melt.

16. The method of claim 15, wherein the crystal comprises an organic molecule comprising a donor, an acceptor, and a conjugated backbone.

17. The method of claim 12, wherein forming of the waveguide further comprises:
growing a crystal by controlling a rate of evaporation of a solution.

18. The method of claim 17, wherein the crystal comprises an organic molecule comprising a donor, an acceptor, and a conjugated backbone.

19. The method of claim 12, wherein forming of the waveguide further comprises:
aligning dipole moments of the waveguide with the electric field as the waveguide crystallizes.

20. The method of claim 12 further comprising:
applying a voltage to the two electrodes to modulate a light signal in the waveguide.

21. A method of changing a phase of an optical signal in an electro-optic modulator comprising two electrodes and an organic crystalline waveguide situated between the two electrodes, the organic crystalline waveguide having dipole moments substantially aligned in a common orientation, the method comprising:
introducing the optical signal into the organic crystalline waveguide; and
applying a voltage to the two electrodes.

22. The method of claim 21, wherein applying the voltage to the two electrodes changes a refractive index of the organic crystalline waveguide.

23. An optical system comprising:
a laser;
an electro-optic modulator comprising two electrodes and an organic crystal waveguide between the two electrodes, the waveguide having its dipole moments substantially aligned in a common direction, the waveguide positioned to receive a light signal from the laser, the electrodes of the waveguide coupled to a signal input.

24. The optical system of claim 23 further comprising:
an amplifier to amplify a modulated light signal from the electro-optic modulator.

25. The optical system of claim 24 further comprising:
a MUX/DEMUX coupled to the electro-optic modulator.

26. The optical system of claim 25, wherein the MUX/DEMUX is an array waveguide grating.

27. An electro-optic modulator comprising:
a splitter;
a coupler; and
a phase modulator comprising an organic crystal having its dipole moments substantially aligned in a common direction, wherein the splitter is coupled to direct a first portion of a light signal to the phase modulator and a second portion of the light signal to the coupler, and the coupler is coupled to recombine an optical signal output from the phase modulator with the second portion of the light signal.

28. The electro-optic modulator of claim 27, wherein the splitter and the coupler are the same device.
